SEQUENCE LISTING (12 sequences)

SEQ ID NO: 1 - DNA, 585 bp, Bovine
  CDS (1)..(585): Recombinant TIMP-2 protein
atgtgcagctgctccccggtgcacccgcaacaggcgttttgcaatgcagacatagtgatcagggccaaagcagtcaataagaaggaggtggactctggcaacgacatctacggcaaccccatcaagcggattcagtatgagatcaagcagataaagatgttcaagggacctgatcaggacatagagtttatctacacagccccctcctctgccgtgtgtggggtctcgctggacattggaggaaagaaggagtatctcattgcagggaaggccgaggggaatggcaatatgcatatcaccctctgtgacttcatcgtgccctgggacaccctgagtgccacccagaagaagagcctgaaccacaggtaccagatgggctgtgagtgcaagatcactcgatgccccatgatcccatgctacatctcctctccggacgagtgcctctggatggactgggtcacggagaagaacatcaacggacaccaggccaagttcttcgcctgcatcaagagaagcgacggctcctgcgcctggtaccgcggagcagcaccccccaagcaggagtttctggacatcgaggacccg

SEQ ID NO: 2 - protein, 195 aa, Bovine
MCSCSPVHPQQAFCNADIVIRAKAVNKKEVDSGNDIYGNPIKRIQYEIKQIKMFKGPDQDIEFIYTAPSSAVCGVSLDIGGKKEYLIAGKAEGNGNMHITLCDFIVPWDTLSATQKKSLNHRYQMGCECKITRCPMIPCYISSPDECLWMDWVTEKNINGHQAKFFACIKRSDGSCAWYRGAAPPKQEFLDIEDP

SEQ ID NO: 3 - DNA, 603 bp, Bovine
  CDS (1)..(603): Recombinant FAA protein
atggagaagctaaacggaaattcaagaaaaggcataacatacaactatgtgattagctctcgccttggaagaaacacatataaagaacagtatgcctttctctataaagaaaagctagtgtctgtaaaacaaagctacctctaccacgactatcaggctggagacgcagatgtgttttccagggaaccctttgtggtctggttccagtcaccctacaccgctgtcaaggacttcgtgattgtccccctgcacaccacccctgagacatccgttagagagattgatgagctggctgatgtctacacagatgtgaaacgtcgctggaatgcagagaatttcattttcatgggtgacttcaatgctggctgcagctacgtccccaagaaggcctggaaggacatccgcctgaggacggaccccaagttcgtttggctgatcggggaccaagaggacaccacggtcaagaagagcacaaactgcgcctatgacaggatcgtgcttagaggacaaaatattgtcaactctggtggtcctcaatcaaacctcgtctttgatttccagaaagcttacaggttgtctgaatcgaaggccctggatgtcagc

SEQ ID NO: 4 - protein, 201 aa, Bovine
MEKLNGNSRKGITYNYVISSRLGRNTYKEQYAFLYKEKLVSVKQSYLYHDYQAGDADVFSREPFVVWFQSPYTAVKDFVIVPLHTTPETSVREIDELADVYTDVKRRWNAENFIFMGDFNAGCSYVPKKAWKDIRLRTDPKFVWLIGDQEDTTVKKSTNCAYDRIVLRGQNIVNSGGPQSNLVFDFQKAYRLSESKALDVS

SEQ ID NO: 5 - DNA, 51 bp, Artificial
  PCR primer
atgggcgccgccgcccgcagcctgccgctcgcgttctgcctcctgctgctg

SEQ ID NO: 6 - DNA, 44 bp, Artificial
  PCR primer
tcaatgatgatgatgatgatgcgggtcctcgatgtccagaaact

SEQ ID NO: 7 - DNA, 18 bp, Artificial
  PCR primer
atgtgcagctgctccccg

SEQ ID NO: 8 - DNA, 24 bp, Artificial
  PCR primer
cgggtcctcgatgtccagaaactc

SEQ ID NO: 9 - DNA, 21 bp, Artificial
  PCR primer
atggagaagctaaacggaaat

SEQ ID NO: 10 - DNA, 19 bp, Artificial
  PCR Primer
gctgacatccagggccttc

SEQ ID NO: 11 - protein, 225 aa, Bovine
  MISC_FEATURE (196)..(225): 3′ vector sequence and C-terminal 6x His tag
MCSCSPVHPQQAFCNADIVIRAKAVNKKEVDSGNDIYGNPIKRIQYEIKQIKMFKGPDQDIEFIYTAPSSAVCGVSLDIGGKKEYLIAGKAEGNGNMHITLCDFIVPWDTLSATQKKSLNHRYQMGCECKITRCPMIPCYISSPDECLWMDWVTEKNINGHQAKFFACIKRSDGSCAWYRGAAPPKQEFLDIEDPKGNSKLEGKPIPNPLLGLDSTRTGHHHHHH

SEQ ID NO: 12 - protein, 231 aa, Bovine
  MISC_FEATURE (202)..(231): 3′ vector sequence and C-terminal 6x His tag
MEKLNGNSRKGITYNYVISSRLGRNTYKEQYAFLYKEKLVSVKQSYLYHDYQAGDADVFSREPFVVWFQSPYTAVKDFVIVPLHTTPETSVREIDELADVYTDVKRRWNAENFIFMGDFNAGCSYVPKKAWKDIRLRTDPKFVWLIGDQEDTTVKKSTNCAYDRIVLRGQNIVNSVVPQSNLVFDFQKAYRLSESKALDVSKGNSKLEGKPIPNPLLGLDSTRTGHHHHHH

(19) United States
(12) Patent Application Publication
(10) Pub. No.: US 2007/0166694 A1
(43) Pub. Date: Jul. 19, 2007

(54) COMPOSITION AND METHOD TO INCREASE MAMMALIAN SPERM FUNCTION

(76) Inventors: Tod C. McCauley, Tucson, AZ (US); Huanmin Zhang, Okemos, MI (US); Roy L. Ax, Tucson, AZ (US)

Correspondence Address: DEWITT ROSS & STEVENS S.C., 8000 EXCELSIOR DR, SUITE 401, MADISON, WI, 53717-1914, US

(21) Appl. No.: 11/624,799

(22) Filed: Jan. 19, 2007

Related U.S. Application Data
(60) Provisional application No. 60/760,312, filed on Jan. 19, 2006.

(51) Int. Cl. A01N 1/02

(52) U.S. Cl. 435/2

(57) ABSTRACT

A composition of matter for increasing the motility and/or percentage of intact acrosomes (PIA) in sperm is described. The composition includes, in combination, an amount of FAA and an amount of TIMP-2, wherein the amounts are effective to increase the motility, the PIA, or the motility and PIA of sperm contacted with the composition. The composition can be used as a cryopreservation medium for sperm.

### CROSS-REFERENCE TO RELATED APPLICATIONS

Priority is hereby claimed to provisional application Ser. No. 60/760,312, filed Jan. 19, 2006, which is incorporated herein.

### FIELD OF THE INVENTION

The invention is directed to compositions comprising a combination of fertility-associated antigen (FAA) and type-2 tissue inhibitor of metalloproteinases (TIMP-2). The invention is further directed to a method of using the compositions to increase the functionality of mammalian sperm in general, and, more specifically, to increase the functionality of sperm contained in cryopreserved semen.

### BIBLIOGRAPHY

Complete bibliographic citations of the papers cited herein are contained in the bibliography section, immediately preceding the claims. The papers cited in the bibliography are incorporated herein by reference.

### BACKGROUND

It has been well-documented that seminal fluid is a complex mixture consisting of secretions of the male accessory organs of reproduction, i.e., the seminal vesicles, the prostate, and the bulbourethral glands. Of the seminal fluid constituents discovered and characterized to date, some have been shown to inhibit and others to stimulate sperm capacitation in vitro.

Seminal components that stimulate capacitation include a family of heparin-binding proteins (HBP) that bind to sperm ejaculation and convey heparin-induced capacitation (Miller, 1990). A murine monoclonal antibody (mAb), M1, generated by immunization with purified HBP, recognized three distinct proteins in immunoblots of bovine sperm extracts (Bellin et al., 1996, 1998). One of the three HBPs was apparent to be a single 31-kDa mass and was described as fertility-associated antigen (FAA; Bellin et al., 1998). The polynucleotide coding sequence for the heparin-binding protein designated as FAA, and the amino acid sequence of FAA, are distinctly different from other seminal proteins. Isolated polynucleotides that encode non-human FAA have been described. See U.S. Pat. No. 6,891,029, issued May 10, 2005.

Type-2-tissue inhibitor of metalloproteinases (TIMP-2) is a normal constituent of semen from bulls (Calvete et al., 1996, McCauley et al., 2001), humans (Baumgart et al., 2002; Shimokawa et al., 2003), rats (Siu and Cheng, 2004), and rams and stallions (Metayer et al., 2002). TIMP-2 is produced in various cell types including the testis and the accessory sex glands. TIMP-2, like FAA, is secreted from these glands. TIMP-2 binds to sperm traversing the urogenital tract during ejaculation. TIMP proteins, four (4) of which have been described, inhibit the catalytic activity of matrix metalloproteinases (MMPs) (Nagase et al., 1999). MMPs are mediators of various reproductive processes, including ovulation, implantation, parturition, involution, and prostate and testicular function (Hulboy et al., 1997). MMPs have been localized to the acrosome and midpiece of normal and abnormal human sperm (Buchman-Shaked et al., 2002). TIMP-2 preferentially regulates MMP-2 by inhibiting the cleavage or conversion of inactive pro-MMP-2 zymogen to its active form (Brew et al., 2000). In a retrospective analysis, Dawson et al. (2002) reported that bulls which possessed TIMP-2 in detergent extracts of sperm were 13% more fertile than TIMP-2-negative bulls. TIMP-2 is a heparin-binding protein (McCauley et al., 2001).

Fertility-associated antigen (FAA) is a seminal protein produced in bovine accessory sex glands. FAA binds to sperm at ejaculation (McCauley et al., 1999). It is a non-glycosylated, basic, approximately 31 kDa protein that shares a high degree of homology with an emerging family of DNase-I-like proteins. The bovine FAA cDNA sequence displayes 88% identity to DNase-1-like-3 (DNase1L3), a gene cloned from human liver expressed sequence tags (EST) (Rodriguez et al., 1997). DNase1L3 nomenclature in the literature includes LS-DNase and DNase I homolog protein 2. DNase1L3 is expressed primarily in liver and spleen cells. FAA was identified (McCauley et al., 1999) as a minor constituent among bovine seminal HBPs. Expression of FAA originates in the seminal vesicles, prostate and bulbourethral glands. FAA has been detected in semen from bulls, boars, rams, goats, dogs and humans, and has been localized primarily to the acrosomal region of the sperm head (Dawson et al., 2003).

The predicted DNase1L3 protein was 45% identical to classical DNase-I, the well-characterized pancreatic enzyme (Kinshi et al., 1989). The DNase-I-like family members differ from DNase-I with respect to enzyme activity, regulation and loci of expression and their biological role has yet to be defined. FAA is a protein marker of higher fertility in bulls; sperm extracts containing detectable FAA by Western blots were indicative of higher bull fertility compared to sperm extracts without detectable FAA. This observation includes bulls used for natural service and exposed to cows at a ratio of one bull per 25 cows in multiple sire pastures (Bellin et al., 1994; 1996; 1998) or bulls bred to heifers and cows utilizing a single artificial insemination (Sprott et al., 2000). It is hypothesized that FAA is involved in regulation of sperm capacitation and/or induction of the acrosome reaction due to its heparin binding characteristics. The response of sperm in vitro to heparin supplemented media is characterized by a dose-response increase in acrosome reactions upon exposure to an appropriate inducer (Ca²⁺ ionophore, zona pellucida, or a fusogenic agent such as lysophosphatidylcholine), and the ability of sperm to undergo acrosome reactions under such conditions is positively correlated to fertility of bulls (Ax and Lenz, 1987). Heparin-binding proteins, when isolated from seminal plasma, potentiated heparin-induced capacitation (Miller et al., 1990).

Detection of FAA in semen samples is possible with a monoclonal antibody designated M1 (Bellin et al. 1998) or a polyclonal anti-recombinant FAA antisera which was recently described (McCauley et al., 2004). When semen samples from 914 bulls were screened for FAA, 26% of the samples resulted in FAA not being detected (McCauley et al., 2004). A similar incidence of FAA-negative bulls was recently reported (Sprott et al., 2006). Lower fertility bulls produce sperm that display a poorer ability to undergo capacitation in response to heparin in vitro (Ax et al., 1985; Ax & Lenz, 1987; Lenz et al., 1988).

Of critical concern to the artificial insemination industry (both for humans and other mammals) is success rate. The critical measure of success, of course, is the number of live offspring yielded per artificial insemination event. Thus, conditions that contribute to elevated capacitation rates, which in turn lead to a greater proportion of sperm in an ejaculate being capable of fertilizing an oocyte, confer extremely valuable advantages in the highly competitive field of human and animal fertility treatments, artificial insemination protocols, animal husbandry using in vitro fertilization, and the like.

### SUMMARY OF THE INVENTION

The invention is directed to compositions and corresponding methods that improve the fertility of semen samples used for artificial insemination. The invention functions to improve the functionality of non-gender sorted sperm and gender-sorted sperm, in both fresh and cryopreserved semen. Thus, a first version of the invention is directed to a composition of matter for increasing motility or percentage of intact acrosomes (PIA) in sperm, the composition comprising, in combination, an amount of FAA and an amount of TIMP-2, wherein the amounts are effective to increase the motility, the PIA, or the motility and PIA of sperm contacted with the composition. The FAA and the TIMP-2 may be disposed in a semen storage medium, such as Tyrode's albumin-lactate-pyruvate medium (TALP). The concentrations of the FAA and the TIMP-2 in the composition are such that, at the point of contact, the sperm are disposed in an environment ranging from about 5 μg/mL to about 200 μg/mL FAA, and about 5 μg/mL to about 200 μg/mL TIMP-2, more preferably about 5 μg/mL to about 100 μg/mL FAA and about 5 μg/mL to about 100 μg/mL TIMP-2, and more preferably still about 10 μg/mL to about 50 μg/mL FAA and about 10 μg/mL to about 50 μg/mL. It is preferred that both the FAA and the TIMP-2 be recombinant proteins. The composition of matter according to the present invention may be lyophilized, in which case it is hydrated with an appropriate medium prior to contacting it with sperm.

Another version of the invention is directed to a method to improve the functionality of sperm (as well as to store sperm cryogenically prior to use). The method comprises contacting sperm with a composition of matter as described in the immediately prior paragraphs. The method may be used to improve the functionality of gender-sorted sperm and/or non-gender-sorted sperm. The method optionally further comprises, after contacting the sperm with the inventive composition of matter, freezing or cryopreserving the sperm in the presence of the composition of matter.

Yet another version of the invention is a kit for increasing motility or percentage of intact acrosomes (PIA) in sperm. The kit comprises, in combination, a composition of matter as described in the preceding paragraphs, the composition disposed in a suitable container. The amounts of the FAA and TIMP-2 included in the kit are effective, in combination, to increase the motility, the PIA, or the motility and the PIA of sperm contacted with the composition. The kit optionally includes instructions for how to use the kit.

The invention includes compositions comprising a combination of FAA and TIMP-2 in unit dosage forms. That is, the combination of FAA and TIMP-2 is provided in concentrated form (e.g., a concentrated solution or lypholized) and packaged such that the entire contents of the package yields a solution having suitable concentrations of the FAA and TIMP-2 when the package contents are added to an appropriate amount of a semen storage media.

### BRIEF DESCRIPTION OF THE DRAWINGS

FIGS. 1A and 1B: Time course of recombinant FAA (rFAA) induction. Bacterial cultures were induced with IPTG as described herein. One (1) mL samples were collected at 0, 2 and 4 hours relative to inducing protein expression. Extracts prepared with non-denaturing (50 mM KPO₄, 400 mM NaCl, 100 mM KCl, 10% glycerol, 0.5% Triton X-100, and 10 mM imidazole, pH 7.8) lysis buffer (FIG. 1A, soluble) or with denaturing 8M urea buffer (FIG. 1B, insoluble) were analyzed separately by sodium dodecylsulfate-polyacrylamide gel electrophoresis (SDS-PAGE). Induced (“i”) and un-induced (“ui”) fractions at each time point are depicted. rFAA appeared as the predominant protein from the induced sample in the fraction that was insoluble (FIG. 1B, lane “4 h i”). M=molecular mass marker.

FIGS. 2A and 2B: Expression and detection of rFAA. Sol=soluble lysate extracted with non-denaturing lysis buffer; Insol=insoluble inclusion bodies lysed in Laemmli sample buffer; UI=un-induced control lysate; I=induced (0.5 mM IPTG) lysate. FIG. 2A depicts the SDS-PAGE gel. FIG. 2B depicts the Western blot. Western blot was performed with horseradish peroxidase conjugated anti-His (6×) antibody (1:5000 dilution). rFAA was specifically recognized by the antibody at the appropriate molecular mass verifying highly inducible rFAA expression. M=molecular mass marker.

FIG. 3: Purification of rFAA. Bacterial cell pellet from 25 mL liquid culture was lysed (S=starting material) with 4 mL denaturing buffer (8M urea) and mixed with 1 mL (0.5 mL bed vol) BD Talon-brand metal affinity resin for 20 min. The unbound (UB) material was collected, resin was washed with 5 mL (10× bed vol) buffer (W1) for 10 min., the wash was repeated (W2) and rFAA was eluted with 0.5 mL (1× bed vol) of denaturing buffer containing 250 mM imidazole (E1-5). A highly purified recombinant FAA is visible as a single band in eluted fractions. M=molecular mass marker.

FIG. 4: Affinity purified, refolded rFAA. Purified rFAA was dialyzed and refolded as described in the Detailed Description. M=molecular mass marker; rFAA=final purified product.

FIG. 5: Time course of rTIMP-2 induction. Bacterial cultures were induced with IPTG as described in the Detailed Description. One (1) mL samples were collected at 2 and 4 hours relative to inducting protein expression. Extracts were prepared with denaturing 8M urea buffer and analyzed by SDS-PAGE. The gel was stained with Coomassie blue. Un-induced (“ui”) and induced (“i”) fractions at each time point are depicted. Inducible rTIMP-2 was clearly detected at 2 and 4 h (i) compared to 2 and 4 h (ui). M=molecular mass marker.

FIGS. 6A and 6B: Expression and detection of rTIMP-2. Induced (0.5 mM IPTG) lysates were prepared after 2 hours of expression culture. Soluble and insoluble fractions were analyzed by SDS-PAGE (FIG. 6A) and Western blotting (FIG. 6B). FIG. 6A depicts a Coomassie blue-stained gel and FIG. 6B shows a Western blot performed with horseradish peroxidase conjugated anti-His (6×) antibody (1:5000 dilution). Sol=soluble lysate; Insol=insoluble inclusion bodies. M=molecular mass marker. rTIMP-2 (indicated by the arrow in FIGS. 6A and 6B) was easily detected by Coomassie blue staining in the insoluble fraction. While the sensitivity of Western blotting detected rTIMP-2 in the soluble fraction, a much more intense band of rTIMP-2 was present in the insoluble fraction, reflecting the differences detected by Coomassie blue staining.

FIGS. 7A and 7B: Purification of rTIMP-2 from 2-hour expression cultures. The bacterial cell pellet was lysed (S=starting material) with denaturing buffer and mixed with BD Talon-brand metal affinity resin for 20 min. The unbound (UB) material was collected, resin was washed with buffer (W1, W2) and rTIMP-2 was eluted with 0.5 mL (1× bed vol) of denaturing buffer containing 250 mM imidazole (E1, E2). M=molecular mass marker. SDS-PAGE (FIG. 7A; Coomassie blue stain) and Western blotting (FIG. 7B; anti-His6) were performed to demonstrate the purity of the purified material.

FIG. 8: Affinity purified, refolded rTIMP-2. Purified rTIMP-2 was dialyzed and refolded as described in the Detailed Description. M=molecular mass marker; 1 and 2=rTIMP-2 product after refolding of two different batch preparations.

FIG. 9: Recombinant FAA-potentiated, heparin-induced capacitation of bovine sperm in vitro. Data were analyzed by analysis of variance between groups (ANOVA). Least squares means and standard error of the means (SEM) are shown. The experiment was repeated four times. Values without a common letter designation differ significantly (p<0.05).

FIG. 10: Recombinant TIMP-2 potentiated, heparin-induced capacitation of bovine sperm in vitro. Data were analyzed by ANOVA. Least squares means and SEM are shown. The experiment was repeated four times. Values without a common letter designation differ significantly (p<0.05).

FIG. 11: Combined effect of rFAA and rTIMP-2 on acrosome reactions. There was no significant interaction between treatments. Within a rTIMP-2 dose, different letter designations differ significantly (p<0.05).

FIG. 12: Combined rFAA and rTIMP-2 improve acrosome integrity (percent intact acrosomes, PIA, ▪) and percent motility (--♦--) of bull sperm subjected to cryopreservation, particularly at lower sperm concentrations (10×10⁶ sperm/straw).

FIG. 13: rFAA binds to sperm membranes. Freshly collected neat bull semen was supplemented with 25 μg/ml empty vector (lanes 1 and 3) or 25 μg/ml rFAA (lanes 2 and 4) and incubated for 20 minutes prior to commercial cryopreservation. Semen was thawed, sperm cells were washed 3 times, and cell lysates were evaluated by Western blotting with the anti-His₆₆× antibody. A single band was detected in samples which were supplemented with rFAA indicating that adding recombinant protein directly to neat semen is sufficient to allow uptake by sperm cells. Similar results were observed using rTIMP-2 (data not shown).

### DETAILED DESCRIPTION OF THE INVENTION

Abbreviations and Definitions: The following abbreviations and definitions are used throughout the specification and claims. Terms not explicitly defined herein are to be given their accepted definition within the fields of enzymology, biochemistry and/or artificial insemination technologies.

ANOVA=analysis of variance between groups.

BSA=bovine serum albumin.

EST=expressed sequence tag.

FAA and rFAA=fertility-associated antigen and recombinant fertility-associated antigen, respectively.

HBP=heparin-binding protein.

IPTG=isopropyl β-D-1-thiogalactopyranoside, a common inducer of the lac operon.

LB media=Lysogeny broth (also often referred to as Luria-Bertani media or Luria broth). LB is a commercially-available media (e.g., Invitrogen) widely used for general maintenance and propagation of E. coli cells. (For an interesting historical footnote on the meaning of “LB” see Bertani, G. (2004), “Lysogeny at Mid-Twentieth Century: P1, P2, and Other Experimental Systems,” J. Bacteriol. 186(3):595-600.)

LPC=lysophosphatidylcholine.

MMP=matrix metalloproteinases.

PBS-T=phosphate buffered saline with 3% Tween-20.

PIA=percent intact acrosomes.

RACE=rapid amplification of 5′ complementary DNA ends.

RT-PCR=Reverse Transcriptase-Polymerase Chain Reaction. A host of conventional PCR and RT-PCR protocols are known in the art and will not be described in any detail herein. Likewise, a host of commercial kits are available for cloning and expressing desired nucleic acid sequences and for separating, identifying, and isolating the resulting protein. Unless otherwise noted, all molecular biological manipulations and protocols noted herein can be found in “Molecular Cloning—A Laboratory Manual, Third Edition,” by Joseph Sambrook & David W. Russell, copyright 2001, Cold Spring Harbor Press (Cold Spring Harbor, N.Y.), ISBN: 0-87969-576-5, incorporated herein by reference.

SDS-PAGE=sodium dodecylsulfate-polyacrylamide gel electrophoresis.

SEM=standard error of the means.

Semen storage media=any media designed for storing fresh or frozen (i.e., cryopreserved) semen, including, without limitation, TALP media.

SOC medium=The derivation of the acronym is murky, but is generally taken to designated “super optimal broth—catabolite suppression.” SOC medium is available commercially from a number of suppliers, including Invitrogen (catalog no. 15544-034). See also Hanahan, D. (1983) “Studies on Transformation of Escherichia coli with Plasmids,” J. Mol. Biol. 166(4): 557-580.

TALP media=Tyrode's albumin-lactate-pyruvate media. TALP media are used for preparing sperm, for in vitro fertilization, for washing oocytes and embryos, and the like. TALP media are available commercially, from, for example, Millipore/Specialty Media (Phillipsburg, N.J.).

TIMP-2 and rTIMP-2=type-2 tissue inhibitor of metalloproteinases and recombinant type-2 tissue inhibitor of metalloproteinases, respectively.

The present invention is a composition of matter and a corresponding method to enhance sperm function in terms of motility and percent intact acrosomes of sperm following cryopreservation of either neat semen and/or gender-sorted sperm. TIMP-2 and FAA cDNAs were cloned from bovine seminal vesicles, recombinant fusion proteins were engineered and expressed using a prokaryotic expression system, and the purified recombinants were evaluated as therapeutic additives to bovine semen. rTIMP-2 and rFAA stimulated, in a dose-response manner, the ability of sperm to undergo the acrosome reaction following heparin-induced capacitation. A composition comprising a combination of FAA and TIMP-2 also improved the quality of neat and gender-sorted semen following cryopreservation by increasing the motility and percentage of sperm with intact acrosomes after a 3-hour incubation at 38° C. post-thaw. Thus the utility of the present invention is that it improves the fertility of mammalian semen. Such therapeutic measures are applicable to either standard-dose inseminations or situations requiring low-dose inseminations, such as in the commercial use of gender-sorted sperm. The invention also particularly benefits semen samples from bulls whose sperm otherwise respond poorly to cryopreservation.

While the experiments described in the examples were performed using bovine semen, TIMP-2 and FAA expression has been documented in a host of economically important species, including horses, pigs, sheep, dogs and humans. Sperm from all of these types of mammals also benefits from the compositions described herein.

As described in the examples, the polymerase chain reaction (PCR) was used to amplify a 585 bp segment of the TIMP-2 gene which was cloned (four identical clones resulted) and sequenced. SEQ. ID. NO: 1 shows the coding region for the TIMP-2 gene; SEQ. ID. NO: 2 shows the corresponding protein. The actual 225 amino acid translated gene product is shown in SEQ. ID. NO: 11. SEQ. ID. NO: 11 differs from SEQ. ID. NO: 2 only in that it contains 24 residues encoded by the 3′ end of the vector itself, and six (6) C-terminal histidine residues. The position and sequence of the vector-encoded residues and the His₆-tagged C-terminal tail are indicated in the Sequence List. The rTIMP-2 expression clone encompasses the entire mature peptide of the bovine TIMP-2 gene (gb: M32303), resulting in a protein product of 225 amino acids (25.2 kDa) including the vector-derived C-terminal His₆-tag. (See SEQ. ID. NO: 11.)

PCR was used to amplify a 603 bp fragment of bovine FAA from seminal vesicular cDNA. SEQ. ID. NO: 3 shows the coding region for the FAA gene; SEQ. ID. NO: 4 shows the corresponding protein. The gene was cloned into an expression vector (pCR®T7/CT-TOPO®) and individual clones were screened and sequenced. Six rFAA clones resulted: four of those (A1-5, A1-9, A2-1 and A2-3) were identical to each other and were exactly as designed; the other two each contained a single base substitution introduced during PCR. Clone A1-6 had an “A₅₆₂→G” nucleotide substitution resulting in a “K₁₈₈→E” mutation in the translated protein. Clone A1-10 had an “A₂₅₆→C” nucleotide substitution resulting in a “T₈₆→P” mutation in the translated protein. The consensus 603 bp nucleotide sequence of the four identical clones is depicted in SEQ. ID. NO: 3 and the translated gene product is shown in SEQ. ID. NO: 4. Clone A1-5 was transformed into prokaryotic expression cells (BL21(DE3)pLysS) and rFAA was produced as a His₆-tagged fusion protein. The actual 231 amino acid translated gene product is shown in SEQ. ID. NO: 12. SEQ. ID. NO: 12 differs from SEQ. ID. NO: 4 only in that it contains 24 residues encoded by the 3′ end of the vector itself, and six (6) C-terminal histidine residues. The recombinant FAA product totals 231 amino acids with a molecular mass of 26.7 kDa including the His₆-tag. (See SEQ. ID. NO: 12.)

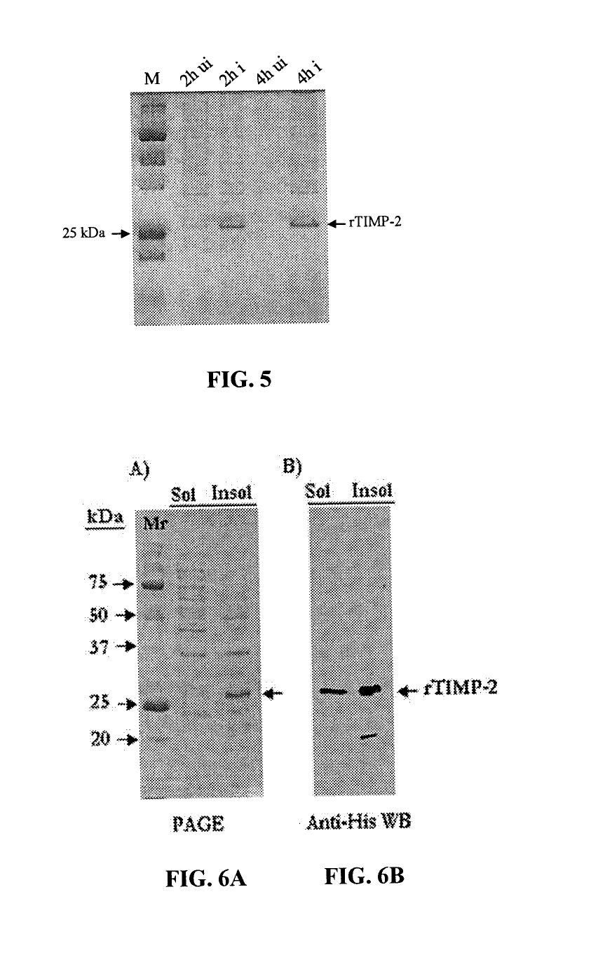

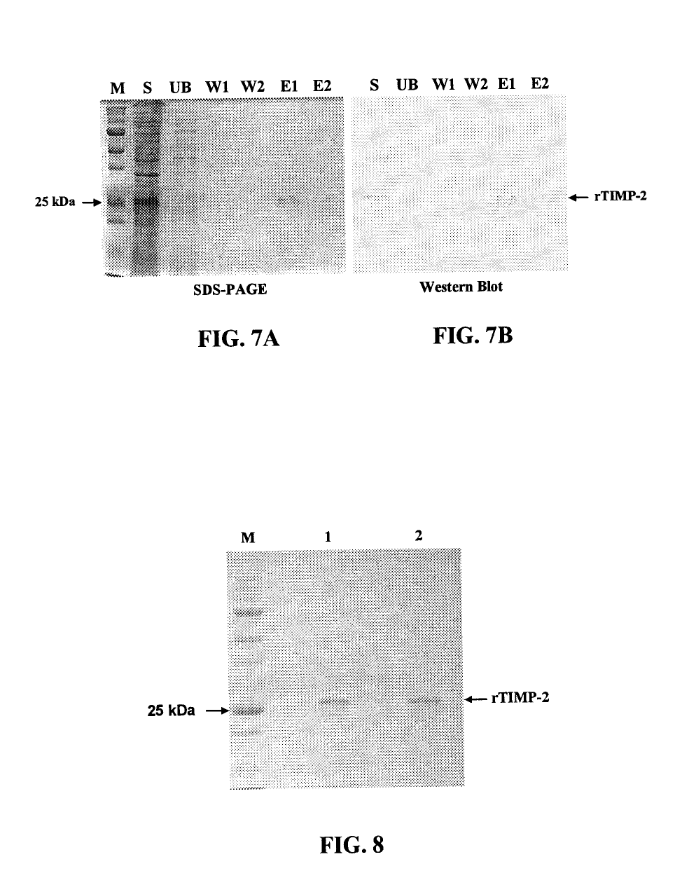

SDS-PAGE analysis of soluble and insoluble fractions of bacterial lysates demonstrated that rTIMP-2 was predominately expressed in the insoluble fraction in the form of inclusion bodies. There was no apparent up-regulation of rTIMP-2 expression in induced cultures incubated for 4 hours as compared to 2 hours (see FIG. 5). Therefore, rTIMP-2 expression cultures were continued 2 hours post-induction with IPTG. Similar to expression of rFAA (more of which below), rTIMP-2 was predominately expressed in the insoluble bacterial lysate (see FIGS. 6A and 6B). Western blotting with the anti-His₆ antibody verified the identity of the His-tagged recombinant protein (see FIG. 6B). rTIMP-2 was purified to near homogeneity from cell lysates using cobalt-based metal affinity resin (anti-His₆). FIGS. 7A and 7B depict a typical purification profile of rTIMP-2 observed by SDS-PAGE (FIG. 7A) and Western blotting (anti-His₆) (FIG. 7B). The whole lysate containing rTIMP-2 (lane S in both FIGS. 7A and 7B) was mixed with metal affinity resin and purified rTIMP-2 was eluted from the resin (FIGS. 7A and 7B; E1-E2). Affinity-purified, denatured rTIMP-2 was refolded by multiple-step dialysis using procedures described in the examples. The final, purified, refolded product (gel shown in FIG. 8) was used in functional sperm assays. Recombinant TIMP-2 and FAA were expressed at relatively high levels (≧50-75 mg/L) under the conditions described herein. The recovery of refolded, purified recombinant protein was approximately 15-25 mg/L culture media (˜30% recovery) across several experimental batches. (See the examples for experimental details.)

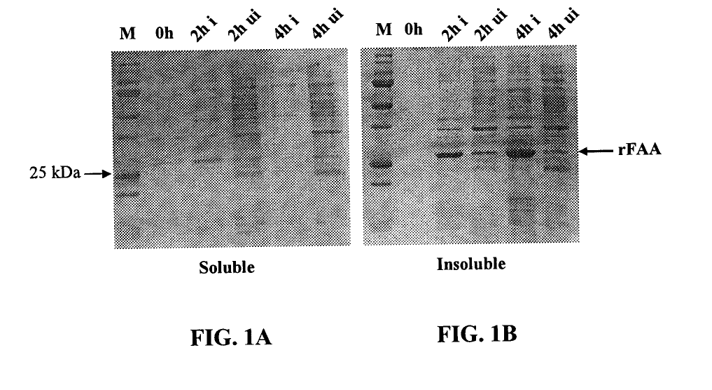

SDS-PAGE analysis of soluble and insoluble fractions of bacterial lysates demonstrated that rFAA was predominately expressed in the insoluble fraction in the form of inclusion bodies. Compare FIG. 1A (soluble fraction) to FIG. 1B (insoluble fraction). The time course of optimal rFAA expression was 4 hours post-induction as shown by the stimulated expression levels of a 27 kDa band. Compare FIG. 1B, lane “4 h i” (4 hours, induced) to FIG. 1B, lane “2 h i” (2 hours, induced) or to any of the lanes marked “ui” (un-induced controls). Therefore, all rFAA expression cultures were continued 4 hours post-induction with IPTG.

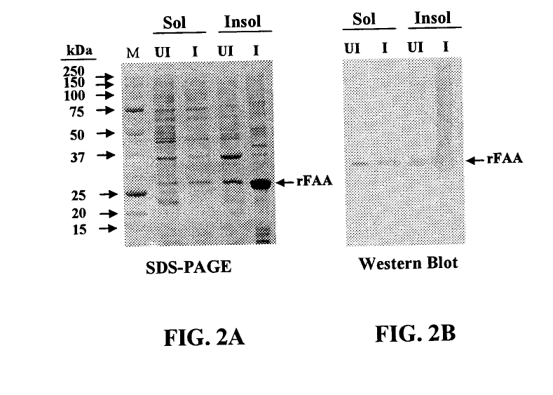

Expression of rFAA was confirmed by Western blotting of 4-hour cultures with an anti-His₆ antibody (see FIG. 2B). Low levels of constitutively expressed rFAA were detected in un-induced samples (soluble and insoluble) by the antibody, similar to levels detected in the induced, soluble sample (see FIG. 2A). The insoluble, induced lysate clearly contained predominately rFAA as demonstrated by the intense cross-reaction of the antibody in Western blots (FIG. 2B).

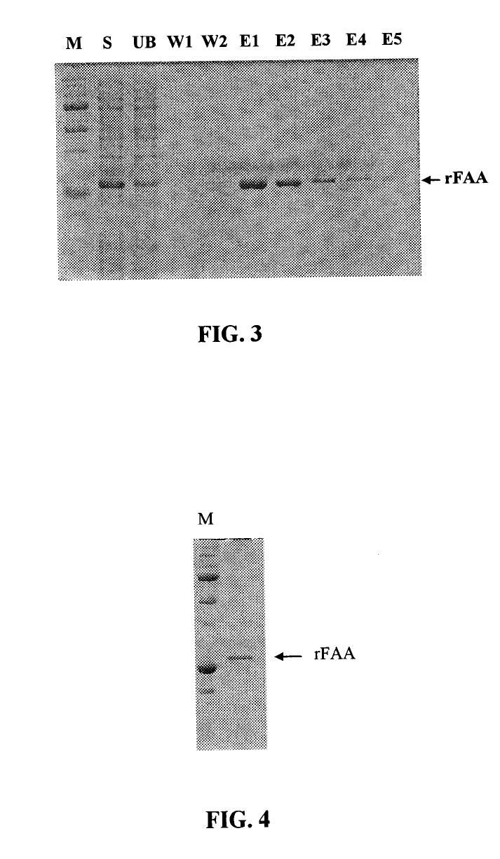

rFAA was purified to near homogeneity from cell lysates using cobalt-based metal affinity resin (anti-His₆) under denaturing conditions. FIG. 3 depicts a typical purification profile observed by SDS-PAGE and Coomassie blue staining. The whole lysate containing rFAA (lane S in FIG. 3) was mixed with metal affinity resin to specifically bind rFAA to the resin. Following multiple washes, purified rFAA was eluted from the resin with five bed volumes of elution buffer consecutively (FIG. 3, lanes E1 to E5). Affinity-purified, denatured rFAA was refolded by multiple-step dialysis into non-denaturing buffer and the final, purified, refolded product (gel shown in FIG. 4) was used in functional sperm assays.

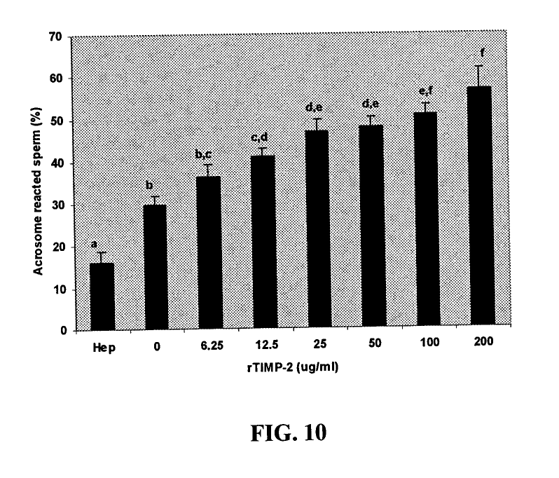

rTIMP-2 potentiated heparin-induced capacitation in a dose-dependent manner. Addition of rTIMP-2 led to a dose response increase in the percentage of acrosome-reacted sperm (P<0.05) above that observed after treatment with heparin alone, or heparin and lysophosphatidylcholine (LPC). See FIG. 10, which is a graph depicting the percentage of acrosome-reacted sperm as a function of rTIMP-2 concentration (μg/mL). Maximum stimulation of acrosome reactions (57%) required addition of 200 μg/mL of rTIMP-2. However, the response observed at 25 μg/mL was not significantly different from either 50 or 100 μg/mL. Control incubations with empty vector lysates were not different from that induced by heparin and LPC alone (data not shown).

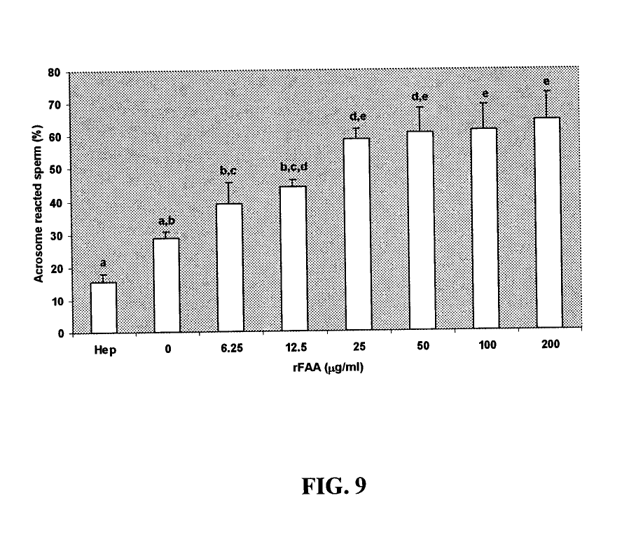

rFAA also potentiated heparin-induced capacitation in a dose-dependent manner. Incubation with heparin alone for 4 hours, without stimulation by LPC (FIG. 9, “Hep”), resulted in induction of acrosome reactions in approximately 16% of the population of sperm (i.e., spontaneous acrosome reactions). Adding LPC at the end of the 4-hour incubation with heparin (FIG. 14, “0”) resulted in approximately 30% acrosome-reacted cells. Addition of rFAA led to a dose-dependent increase in the percentage of acrosome-reacted sperm (p<0.05). A maximum response of approximately 60% reacted sperm was achieved at 25 μg/mL of rFAA (see FIG. 9). The percentage of acrosome-reacted sperm after treatment with bacterial extracts from cultured expression cells transformed with empty vector (negative control without insert) was not different from that induced by heparin and LPC alone (data not shown).

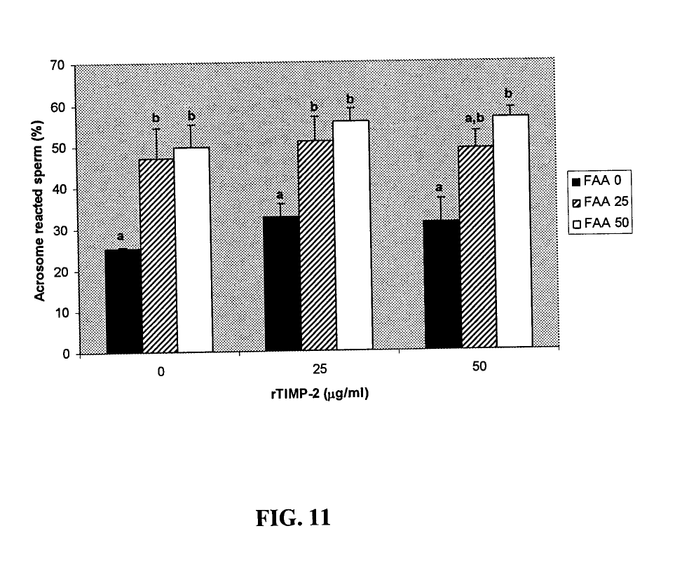

Because rTIMP-2 and rFAA independently stimulated acrosome reactions at concentrations of 25 μg/mL, an experiment was conducted to examine the combined effects of rTIMP-2 and rFAA on acrosome reactions. Cross-over treatments of 0, 25, and 50 μg/mL of rTIMP-2 and rFAA indicated no significant interaction between treatments. No independent rTIMP-2 effect was observed without rFAA treatment, indicating that the effects of rTIMP-2 vary by bull. However, adding rFAA potentiated the rTIMP-2 effect at each dose (see FIG. 11) and resulted in inducing a similar increased percentage of acrosome reactions as was observed in the dose-response experiments of rFAA and TIMP-2 individually. A concentration of 25 μg/mL rTIMP-2 yielded effects that were not different from those observed at the higher dose of 50 μg/mL.

Sperm were then treated with a composition comprising a combination of rTIMP-2 and rFAA. Specifically, motility and acrosomal integrity following cryopreservation of treated and untreated sperm were evaluated. Thus, freshly collected semen samples were treated with 25 μg/mL of a combination of rFAA and rTIMP-2 before undergoing cryopreservation. Cryopreservation was performed according to industry standards. Motility (%) and acrosomal integrity (percent intact acrosomes, PIA) were blindly evaluated immediately after thawing (0 h). Samples were then incubated at 38° C. for 3 hours, at which time the measurements were repeated. The 3-hour incubation period represents the artificial insemination industry's standard quality control test used to determine how well a semen sample is able to withstand the insults associated with cryopreservation and thawing.

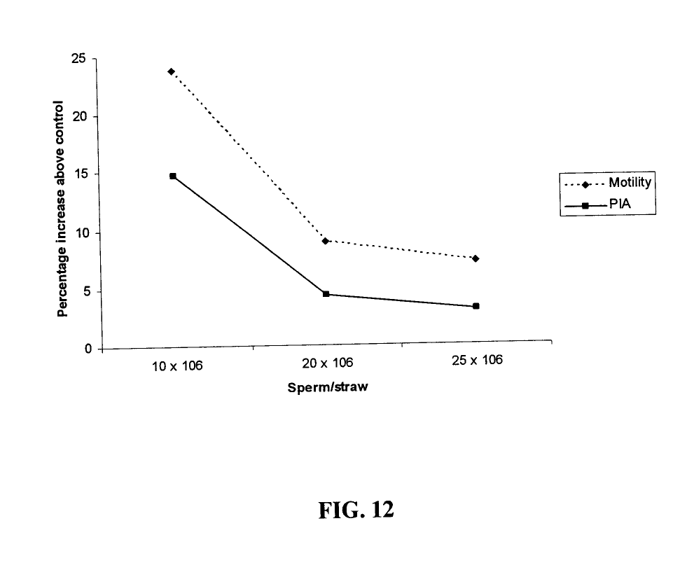

Comparison of treated and control samples three (3) hours post-thaw show that motility was significantly improved by the treatment. Motility was decreased (p<0.0001) after the 3-hour incubation period in control samples (50.4±1.7) as compared to treated samples (55.7±1.6; see Table 1). Similarly, the percentage of sperm with intact acrosomes post-thaw was significantly decreased (p<0.01) after the 3-hour period in control samples (66.9±1.6) as compared to treated samples (70.9±1.3; see Table 1), indicating (it is believed) that the recombinant proteins protected the plasma membrane of cells during cryopreservation. See also the graph shown in FIG. 12. As shown in the graph, treating semen with a combination of rFAA and rTIMP-2 improved both PIA (▪) and percent motility (--♦--) of bull sperm subjected to cryopreservation. The effect was particularly pronounced at lower sperm concentrations (10×10⁶ sperm/straw).

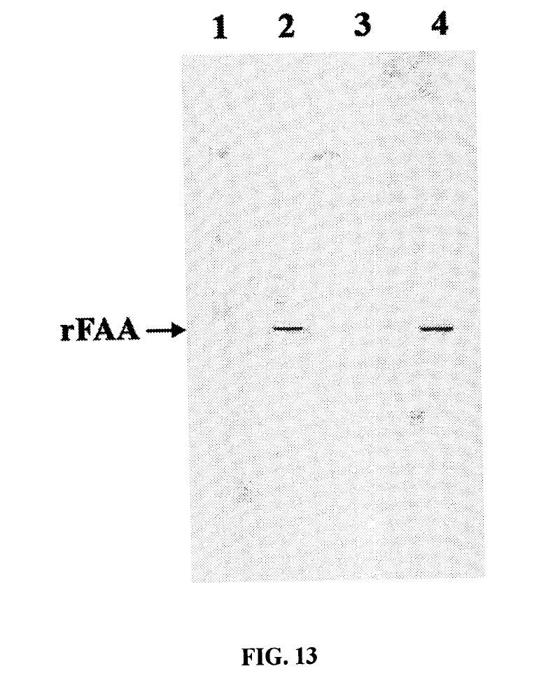

Additionally, it was established that both rFAA and rTIMP-2 bind to sperm membranes when the recombinant proteins are added directly to neat semen. See FIG. 13, which is a gel demonstrating the binding effect. Freshly collected neat bull semen was supplemented with 25 μg/ml empty vector (Lanes 1 and 3 of FIG. 13) or 25 μg/ml rFAA (Lanes 2 and 4 of FIG. 13) and incubated for 20 minutes prior to commercial cryopreservation. The semen was then thawed, sperm cells were washed 3 times, and cell lysates were evaluated by Western blotting using anti-His_{6×} antibody. As shown in FIG. 13, a single band was detected in samples that were supplemented with rFAA indicating that adding recombinant protein directly to neat semen is sufficient to allow uptake by sperm cells. Similar results were observed using rTIMP-2 (data not shown). These results are significant in that they establish that the treatment can be applied directly to neat semen (as well as to sperm cells that have been separated from the seminal fluid and resuspended in different medium).

TABLE 1
Combined effect of rTIMP-2 and rFAA on sperm motility (percent)
and acrosome integrity (percent intact acrosomes, PIA) evaluated
after cryopreservation, thawing, and a 3-hour incubation at 38° C.
Sperm were packaged at either 10×, 20×, or 25 × 10⁶ sperm per
straw. Data represent mean ± SEM. Combined data from all
doses (65 ejaculates from 25 bulls) is presented followed by subsets of
those samples which were evaluated by various sperm concentrations.

| | | |
|---|---|---|
| Treatment | Motility (%) | PIA |

Total, n = 65

| | | |
|---|---|---|
| Control | 50.4 ± 1.7 | 66.9 ± 1.6 |
| rTIMP-2 + rFAA¹ | 55.7 ± 1.6*** | 70.9 ± 1.3** |

10 × 10⁶/straw, n = 6

| | | |
|---|---|---|
| Control | 49 ± 3.7 | 65.8 ± 7.0 |
| rTIMP-2 + rFAA | 60.7 ± 3.5* | 75.5 ± 4.1 |

20 × 10⁶/straw, n = 23

| | | |
|---|---|---|
| Control | 51.8 ± 2.6 | 65.9 ± 2.1 |
| rTIMP-2 + rFAA | 56.4 ± 1.7* | 68.8 ± 1.4^{†} |

25 × 10⁶/straw, n = 26

| | | |
|---|---|---|
| Control | 52.7 ± 3.0 | 67.3 ± 3.4 |
| rTIMP-2 + rFAA | 56.5 ± 2.7^{†} | 69.4 ± 2.6 |

¹Experimental semen samples were supplemented with 25 μg/ml of rTIMP-2 and 25 μg/ml of rFAA at the time of collection. All samples were cryopreserved using industry standard techniques.
²Data were analyzed by Student's t-test; Superscripts represent significance was reached at the indicated level: ***p < 0.0001, **p < 0.01, *p < 0.05, ^{†}p < 0.10.

The results presented in Table 1 illustrate the utility of the present invention. A composition comprising a combination of FAA and TIMP-2 imparts a statistically significant increase in motility, as well as a statistically significant increase in PIA in sperm subjected to cryopreservation and thawing. Both parameters (motility and PIA) are directly proportional to success in artificial insemination. Sperm must be both motile and have an intact acrosome to penetrate an ovum.

Semen samples previously sorted by gender to isolate X chromosome-bearing sperm from Y chromosome-bearing sperm were also subjected to the 3-hour stress test following cryopreservation. Preliminary data indicate that contacting the sperm with a composition comprising a combination of rFAA and rTIMP-2 improved the motility (%) and the PIA of the sperm by an average of 33.1% and 42.5%, respectively. See Table 2.

TABLE 2
Motility and percent intact acrosomes (PIA) of gender-sorted sperm 3
hours post-thaw.

| Treatment | Motility (%) | PIA |
|---|---|---|
| Control | 29.3 | 44 |
| rFAA + rTIMP-2 | 39 | 62.7 |
| Increase above control (%) | 33.1 | 42.5 |

Table 2 presents data from three bulls. Further experiments using gender-sorted sperm are underway to validate the cryoprotective effect of rFAA and rTIMP-2 in those specialized types of semen samples. Despite the small sample size, the data presented in Table 2 are compelling. The data strongly suggest that a cryopreservation solution comprising a combination of FAA and TIMP-2 markedly increases both the motility and the PIA of cryopreserved sperm. As shown in Table 2, motility in the treated sperm was increased 33.1% as compared to untreated controls. PIA in the treated sperm was increased 42.5% as compared to untreated controls. These marked improvements demonstrate the utility of the present invention to increase functionality of cryopreserved sperm.

Thus, the present invention includes transformed cell lines capable of mass-producing two separate seminal proteins as recombinant fusion proteins (rFAA and rTIMP-2). These proteins are useful as semen additives to improve sperm function, especially in cryopreserved semen. A composition comprising a combination of these two proteins recombinant proteins improves sperm function as assayed by responses to heparin-induced capacitation and by acrosome integrity in cells undergoing cryopreservation. (See the examples and the above discussion.) Acrosome reactions are increased by these semen additives and sperm membranes are protected leading to a more functional semen product post-thaw. The beneficial effects are exhibited in both standard cryopreserved sperm and in gender-sorted, cryopreserved sperm.

The invention is particularly suitable in the area of gender-sorted sperm because gender-sorted sperm are known to be less viable and less fertile than conventional (non-sorted) sperm due to the stresses associated with sorting cell populations. Sexed semen samples benefit tremendously from the present invention, because the inventive composition and method are capable of reducing the negative impact on motility and intact acrosomes post-thaw. The beneficial effect is further heightened because current sperm-sexing technologies result in fewer sexed sperm per insemination straw as compared to conventional, non-sexed frozen semen. Thus, the present invention, which increases the functionality of sperm present in each straw, also improves the fertility of semen from bulls that respond poorly to conventional freezing. The invention also increases the functionality of sperm in reduced sperm-number straws and sex-sorted straws. In short, the present invention is capable of increasing the functionality of sperm in sexed-straws to make these gender-sorted semen samples as fertile as their non-sorted counterparts.

The FAA and TIMP-2 genes encoding the recombinant proteins described herein display strong homology across mammals. Thus, the present invention is applicable across a wide range of mammalian species, including all economically important livestock, endangered animals, and humans.

### EXAMPLES

The following examples are included solely to provide a more complete disclosure of the invention described and claimed herein. The examples do not limit the scope of the invention in any fashion.

Chemicals and reagents were obtained commercially from Sigma Chemical (St. Louis, Mo.) unless otherwise stated.

1. Cloning and Sequence Analysis

(a) Type-2 Tissue Inhibitor of Metalloproteinases (TIMP-2):

Purification of a 24 kDa seminal heparin-binding protein (HBP-24) was previously reported (McCauley et al., 2001). Microsequence analysis of HBP-24 purified from seminal fluid identified twenty (20) N-terminal amino acid residues that displayed 90% identity to the N-terminus of a bovine metalloproteinase inhibitor identified as tissue inhibitor of metalloproteinases-2 (TIMP-2; De Clerck et al., 1989). To clone the seminal TIMP-2 gene, bovine TIMP-2 gene-specific primers were designed based on the published bovine aortic cDNA sequence (Boone et al., 1990). Total RNA was extracted from bovine accessory sex gland tissues (seminal vesicles, bulbourethral gland, and prostate). Reverse transcriptase polymerase chain reaction (RT-PCR) procedures were conducted as described by McCauley et al. (2001). Amplification of the partial TIMP-2 cDNA was successful, yielding RT-PCR products from each of the bovine accessory sex glands. Analyses of the DNA sequences of the RT-PCR products from all three glands showed homologies of greater than 95% among them and to the published cDNA sequence (Boone et al., 1990). Subsequently, the entire coding region of the TIMP-2 gene was cloned and sequenced as described below.

(b) PCR Amplification:

Reverse transcription PCR was performed to amplify first strand cDNA from seminal vesicular RNA. cDNA synthesis was catalyzed by the SuperScript™ II Rnase H⁻ RT (GibcoBRL, Grand Island, N.Y.) templated with 5 μg total RNA. First strand cDNA products were used as templates in PCR amplification of partial cDNA segments of the TIMP-2 gene designed on the basis of the bovine aortic TIMP-2 sequence (M32303) as described by McCauley et al. (2001). Gene specific primers were designed to amplify the entire coding sequence of the bovine TIMP-2 gene from seminal vesicles. Primers used were forward: 5′-atgggcgccgccgcccgcagcctgccgctcgcgttctgcctcctgctgctg-3′ (SEQ. ID. NO: 5) and reverse: 5′-tcaatgatgatgatgatgatgcgggtcctcgatgtccagaaact-3′ (SEQ. ID. NO: 6). PCR cycling conditions were 45 sec at 94° C., 45 sec at 57° C., and 1 min at 72° C. for 35 cycles. The amplified PCR product was cloned into the pCR 4-TOPO vector (Invitrogen, Carlsbad, Calif.) according to the manufacturer's instructions and sequenced using an Applied Biosystems 373 A Automated DNA sequencer utilizing the DyeDeoxy-brand terminator chemistry). All sequence data were analyzed with the GCG software (also known as the Wisconsin Package software) (made publicly accessible on-line by the U.S. National Institutes Health, Version 10.0).

Two distinct clones, bTIMP-2 15L and bTIMP-2 25 were isolated and characterized. The first clone, bTIMP-2 15L, carried the gene of interest encompassing all codons for the complete precursor of bTIMP-2. The bTIMP-2 25 clone encoded the mature TIMP-2 peptide. In addition to the TIMP-2 sequence, each clone contained a 6×His tag and stop codon incorporated at the 3′ end of the cDNA. For this example, the bTIMP-2 25 clone was sub-cloned for recombinant TIMP-2 production. The TIMP-2 cDNA was used as template to amplify a 585 bp TIMP-2 fragment (SEQ. ID. NO: 1) coding for the mature TIMP-2 peptide (195 amino acids, SEQ. ID. NO: 2). The PCR product was designed to remain in-frame for authentic TIMP-2 translation with the pCR T7/CT-TOPO vector-incorporated His-tag added at the C-terminus of the protein (SEQ. ID. NO: 11). The sequence of the forward primer was: 5′-atgtgcagctgctccccg-3′ (SEQ. ID. NO: 7); the sequence of the reverse primer was: 5′-cgggtcctcgatgtccagaaactc-3′ (SEQ. ID. NO: 8). Cycling conditions used for PCR were: 95° C. for 2 min followed by 35 cycles of 94° C., 1 min; 58° C., 1 min; and 72° C., 1 min; with a 10 min final extension at 72° C. on an “MASTERCYCLER”®-brand gradient thermal cycler (Eppendorf, Westbury, N.Y.). Fresh PCR products were cloned into the pCR T7/CT-TOPO vector using the “TOPO TA”-brand cloning kit (Invitrogen) following the manufacturer's instructions.

2. Fertility-Associated Antigen (FAA)

The chemical identity of FAA was first described after the native protein was purified from seminal plasma by reversed-phase high performance liquid chromatography (RP-HPLC) and microsequencing analysis (McCauley et al., 1999). The N-terminal sequence of the intact protein, as well as two internal peptides of lys-C digested FAA, were obtained and determined to be homologous with a deduced peptide sequence of a human DNase I-like protein (DNase1L3; Genbank accession no: U56814). Oligonucleotides designed using 5′ and 3′ segments of DNaseIL3 resulted in a 592-bp PCR product transcribed from bovine accessory sex gland RNA. That PCR product was isolated, ligated into pCR®2. 1-TOPO® cloning vector (Invitrogen, Carlsbad, Calif.) and extended by 5′ RACE (i.e., rapid amplification of 5′ complementary DNA ends; see Nature Methods (2005), vol. 2, pages 629-630, incorporated herein by reference). This resulted in the identification of a 900 bp cDNA of FAA (which is described in U.S. Pat. No. 6,891,029). A start codon was preceded by 92 bp of 5′ UTR and a stop codon was not present within the ORF. Thus, the isolated cDNA sequence represented a partial FAA cDNA. Examination of the predicted protein utilizing SignalP3.0 (The Center for Biological Sequence Analysis, Lyngby, Denmark) revealed that amino acid residues 1-20 represented a signal peptide (Bendtsen et al., 2004). The mature peptide sequence thus originated at bp 153 after the peptide cleavage site.

The amino acid sequences previously reported for the native FAA protein (McCauley et al., 1999) were embedded in the deduced protein sequence of the FAA cDNA, thus verifying that the authentic cDNA corresponding to native FAA had been cloned. Sequence analysis with the Blast search engine (Altschul et al., 1990) revealed identity (88%) to a 763 bp segment of DNase I-like III (U56814), a 1079 bp-cDNA with an ORF of 305 amino acids (285 amino acids after cleavage of the signal peptide). Primary protein structure was analyzed using the Conserved Domain Database (accessible through the U.S. National Center for Biotechnology Information, Bethesda, Md.) and the ExPASy (Expert Protein Analysis System) proteomics server sequence analysis tool (accessible through the Swiss Institute of Bioinformatics, Geneva, Switzerland). The partial FAA cDNA (˜90% complete) encoded a 269 amino acid protein with an estimated molecular mass of 30.8 kDa (28.7 kDa after cleavage of the signal peptide) and a predicted isoelectric point (pI) of 9.0 (Wilkins et al., 1998). Those predictions are in agreement with the apparent molecular mass of native FAA by SDS-PAGE as 31 kDa and a basic pI detected by 2-D electrophoresis (McCauley et al., 1999).

Bovine FAA cDNA clones (see U.S. Pat. No. 6,891,029) were utilized as a template to amplify a new recombinant nucleotide fragment (603 bp, SEQ. ID. NO: 3) by PCR to be used as an expression clone to produce rFAA. Newly designed oligonucleotide primers, forward 5′-atggagaagctaaacggaaat-3′ (SEQ. ID. NO: 9) and reverse 5′-gctgacatccagggccttc-3′ (SEQ. ID. NO: 10) successfully amplified the 603 bp product of the FAA gene (DNA shown in SEQ. ID. NO: 3, encoded protein in SEQ. ID. NO: 4). Cycling conditions used for PCR were: 94° C. for 2 min followed by 35 cycles of 94° C., 1 min; 55° C., 1 min; and 72° C., 1 min; with a 10 min final extension at 72° C. on an mastercycler gradient thermal cycler (Eppendorf, Westbury, N.Y.). The fresh PCR product was directly cloned into the pCR T7/CT-TOPO expression vector using the TOPO® TA cloning kit (Invitrogen) following manufacturer's recommendations as described above. Cloned products were transformed using TOP10 F′ One Shot® chemically competent E. coli (Invitrogen). Transformation reactions were incubated on ice (30 min) and heat-shocked at 42° C. for 30 sec. After addition of 250 μl SOC medium, each transformation reaction was placed into an Environ Lab-line shaker (Barnstead International, Dubuque, Iowa) for one (1) hour at 37° C. at 200 rpm. Aliquots (50 μl) of each transformation were spread onto pre-warmed selective LB plates (1.0% tryptone, 0.5% yeast extract, 1.0% NaCl, 1.5% agarose, pH 7.0) supplemented with 50 μg/mL ampicillin and incubated overnight at 37° C. overnight. Single bacterial colonies from each transformation were then selected and inoculated into LB media with ampicillin (50 μg/mL) for an additional 16 hours in a shaking (225 rpm) 37° C. incubator. Cells were harvested and DNA was purified by miniprep procedures (Qiagen Spin Miniprep columns; Qiagen, Valencia, Calif.) according to manufacturer's instructions. Re-PCR was performed using the same oligonucleotide primers described above to confirm presence or absence of the FAA insert in plasmid DNA preparations. Positive clones were selected and sequenced (Applied Biosystems 373 A Automated DNA sequencer utilizing DyeDeoxy m terminator chemistry) at the University of Arizona DNA sequencing facility. PCR products were analyzed by agarose gel (2% wt/vol) electrophoresis in TBE buffer (90 mM Tris, 90 mM boric acid, 2 mM EDTA, pH 8.3) containing ethidium bromide (EtBr; 5 μg/mL) and visualized by ultraviolet illumination. Gels were electrophoresed in a horizontal gel apparatus (Bio-Rad) at 75 V for 20 min followed by 100 V until complete. A 100 bp PCR DNA ladder (EZ Load 100 bp Molecular Ruler, Bio-Rad) served as reference standard. Gel images were analyzed and captured using an ultraviolet light box and CCD camera linked to Alpha Imager™ software (Alpha Innotech Corporation, San Leandro, Calif.). Nucleotide sequence analyses and comparisons were conducted with GCG software (Version 10.0, Genetics Computer Group, Madison, Wis.) and The Biology WorkBench version 3.2 software available on-line from the San Diego Super Computer Center (San Diego, Calif.).

3. Transformation and Expression of rTIMP-2 and rFAA:

The rTIMP-2 and rFAA constructs (10 ng) were individually transformed into OneShot BL21(DE3)pLysS cells (Invitrogen) following the manufacturer's instructions. Cells were mixed with DNA, incubated on ice for 30 min, and heat-shocked for 30 sec at 42° C. Medium was added (250 μl SOC) and incubated for at 37° C. for 30 min in a shaking incubator (Innova 4000, New Brunswick Scientific Co. Inc., Edison, N.J.). The solution was then added to 10 mL of LB medium containing 100 μg/mL ampicillin and 34 μg/mL chloramphenicol and cells were grown overnight at 37° C. with shaking. OneShot BL21(DE3)pLysS cells transformed with no DNA (empty vector) served as a negative control for protein expression studies. The overnight culture was inoculated into 500 mL to 1 L of LB medium (1% tryptone, 0.5% yeast extract, 1% NaCl) containing ampicillin and chloramphenicol and grown until they reached an O.D. of approximately 0.6 (˜2-3 hours). IPTG (isopropyl β-D-thiogalactoside) was added at a final concentration of 0.5 mM to induce expression of rFAA or rTIMP-2 and cultures were grown for an additional 4 hours at 37° C. with shaking. Cells were collected by centrifugation (3,000×g for 20 min at 4° C.) and stored at −20° C. until purification.

Preliminary experiments were conducted to determine the time course of optimal protein expression and to determine whether the recombinant proteins were expressed as soluble proteins or as insoluble material in the form of inclusion bodies. Bacterial cell pellets from 0.5 mL liquid culture were collected at 0, 2 and 4 hours following induction with IPTG and extracted in 0.5 mL lysis buffer (50 mM KPO₄, 400 mM NaCl, 100 mM KCl, 10% glycerol, 0.5% Triton X-100, 10 mM imidazole, pH 7.8). Samples were resuspended in lysis buffer, frozen on dry ice and thawed at 42° C. three times. Insoluble proteins were pelleted by centrifugation at 13,000×g for one minute and SDS-PAGE (Laemmli, 1970) was performed on the soluble and insoluble fractions with 12% polyacrylamide gels. Prestained molecular mass markers (Precision Plus-brand dual color standards, Bio-Rad Labs, Hercules, Calif.) were applied to one lane. Parallel gels were electrophoresed, one was stained with Coomassie-blue (Brilliant blue R-250) and proteins from the other were transferred to a nitrocellulose membrane (Trans-blot (0.2 μm), Bio-Rad) which was probed with anti-His (C-term)-HRP conjugated antibody (Invitrogen, 1:5000 dil. in phosphate buffered saline with 3% Tween-20 (PBS-T)). Detection of both recombinant proteins was based upon the presence of the C-terminal polyhistidine-tag (His₆-tag) incorporated onto the C-terminal end of the expressed proteins. (See SEQ. ID. NOS: 11 and 12.) The blotted membrane was blocked in PBS-T+5% bovine serum albumin (BSA) prior to incubation with antibody. Membranes were rinsed three times in PBS-T+1% BSA and the blot was developed by incubation in HRP substrate (TMB, Promega, Madison, Wis.).

4. Purification of rTIMP-2 and rFAA

The harvested bacterial cell pellet from either rTIMP-2 or rFAA expression cultures was lysed in 80 mL denaturing extraction buffer (8M urea, 50 mM Na PO₄, 300 mM NaCl, pH 7.0) per liter of culture (12.5-fold concentrated extract) and subjected to three (3) freeze-thaw cycles to ensure complete disruption of cells as described above. Extracts were clarified by centrifugation at 13,000×g and the recombinant protein was purified using BD Talon-brand immobilized metal affinity chromatography resin (BD BioSciences, Mountain View, Calif.) according to the manufacturer's instructions. Clarified extracts were mixed with equilibrated Talon resin (8 mL concentrated extract per mL resin) for 20 min, unadsorbed material was removed by centrifugation and the resin was washed 2× with denaturing extraction buffer. The recombinant protein was eluted from the resin by adding 250 mM imidazole to the extraction buffer. Three bed volumes were collected and pooled after aliquots were taken for electrophoresis. The purity of the recombinant protein was assessed by SDS-PAGE and identity of the protein was verified by Western blotting with anti-His antibodies as described herein.

5. Renaturation

(a) rTIMP-2:

Purified rTIMP-2 was renatured by multi-step dialysis. For rTIMP-2 refolding, eluted fractions were pooled and dialyzed (SnakeSkin dialysis tubing, 10 kDa MWCO, Pierce, Rockford, Ill.) in the presence of a reducing agent to prevent disulfide cross-linking during the initial refolding. The reducing agent was removed by dialysis and thiol redox reagents were added to catalyze correct disulfide bond formation and inhibit the formation of non-productive disulfide intermediates with modification of the procedure described by Novagen (EMD BioSciences, San Diego, Calif.). Initial dialysis took place in 50× volume denaturing, reducing buffer (20 mM Tris-Cl, 6 M urea, 10 mM β-mercaptoethanol (β-ME), pH 8.5) for 4 h at 25° C. Buffer was exchanged with fresh denaturing, reducing buffer and dialysis continued for 4 hours at 25° C. Next, the dialysis buffer was changed to non-denaturing, reducing buffer (20 mM Tris-Cl, 10 mM β-ME, pH 8.5) and dialysis was performed for at least 4 hours at 4° C. Buffer was then exchanged with 20 mM Tris-Cl, pH 8.5, and dialysis continued for at least 4 hours at 4° C. Protein was then dialyzed against 25× volume of chilled redox refolding buffer containing 20 mM Tris-Cl, 1 mM GSH (reduced glutathione), 0.2 mM GSSG (oxidized glutathione), pH 8.5 overnight at 4° C. Insoluble aggregates of misfolded protein were removed by centrifugation and clarified. Refolded protein was dialyzed against 20 mM Tris-Cl, pH 7.4 at 4° C. for 3 hours. Soluble protein was concentrated by ultrafiltration (iCON concentrators, 9 kDa MWCO, Pierce) and quantified by protein assay (BCA assay, Pierce). Absorbance was determined with a Biophotometer (Eppendorf, Westbury, N.Y.) and concentration was calculated via a non-linear regression multi-point calibration curve using BSA standards prepared in the last dialysis buffer. Protein samples were aliquoted and stored at −20° C.

(b) rFAA:

Purified rFAA was gradually renatured by multi-step dialysis against 50× volume of buffer first containing 50 mM Na PO₄, 150 mM NaCl, 6 M urea, 0.2 M L-arginine, pH 8.0 (25° C.). After 4 hours, dialysis buffer was exchanged with one containing 50 mM Na PO₄, 150 mM NaCl, 4 M urea, 0.2 M L-arginine, pH 8.0 for 4 hours followed by dialysis against 50 mM Na PO₄, 150 mM NaCl, 2 M urea, 0.1 M L-arginine, pH 8.0, overnight. Insoluble aggregates of misfolded protein were removed by centrifugation following dialysis. Soluble protein was concentrated by ultrafiltration and quantified by the protein assay as described above.

6. Heparin-Induced Capacitation

Purified recombinant protein was added to semen samples incubated under capacitating conditions to determine if rTIMP-2 and/or rFAA potentiated the acrosome reaction following capacitation with heparin. Cryopreserved semen was thawed in a 37° C. water bath for 15 sec and washed 3× in 1 mL of TALP (tyrode's, albumin, lactate, pyruvate) medium (100 mM NaCl, 3.1 mM KCl, 25 mM NaHCO₃, 0.3 mM NaH₂PO₄, 21.6 mM Na lactate, 2 mM CaCl₂, 0.4 mM MgCl₂, 10 mM Hepes, 1 mM pyruvate, 6 mg/mL BSA, 50 μg/mL gentamycin, pH 7.4). Washed sperm from four (4) bulls were incubated with increasing concentrations of purified rTIMP-2 or rFAA (0, 6.25, 12.5, 25, 50, 100, or 200 μg/mL in TALP medium) in the presence of heparin (10 μg/mL; sodium salt from porcine intestinal mucosa; Scientific Protein Laboratories, Waunakee, Wis.) at 38° C. for 4 hours to induce capacitation as previously described (Parrish et al., 1988). Both recombinant proteins were added in a cross-over dose response experiment at concentrations of 0, 25 or 50 μg/mL to examine additive or synergistic effects of the recombinants on capacitation. Bacterial cell lysate (200 μg/mL) from cells transformed with empty vector served as a negative control.

After 4 hours of incubation, 100 μg/mL of the fusogenic agent lysophosphatidylcholine (LPC) was added to induce acrosome reactions in previously capacitated sperm. One sample in each dose response assay was incubated with heparin alone for 4 hours without adding LPC to determine the incidence of spontaneous acrosome reactions. Following LPC treatment, sperm were centrifuged, the pellet was resuspended in PBS and sperm were again pelleted by centrifugation. Sperm were immediately fixed in cold ethanol for 20 min., rinsed in PBS and air-dried onto pre-warmed slides (Esco fluoro slides, Erie Scientific, Portsmouth, N.H.). Sperm were incubated with 5 μg/mL fluoroscein-conjugated PSA (FITC-pisum sativum agglutinin, Vector Labs, Burlingame, Calif.) in the dark for 30 min at 4° C. to stain acrosomal contents. Slides were rinsed with double-distilled H₂O, vectashield mounting medium was added, coverslips were applied and sealed with nail polish. Slides were examined for acrosome reactions with a Leica (Leitz Diaplan) epifluorescent microscope equipped with Nomarski optics at 400× magnification. Unreacted sperm with intact acrosomes were observed as cells with fluorescent staining in the acrosomal cap of the sperm while acrosome-reacted sperm were indicated by a fluorescent staining pattern of equatorial banding or no head fluorescence.

7. Membrane Stability

Freshly ejaculated neat semen from 25 bulls was supplemented with rTIMP-2 and rFAA (25 μg/mL each) (doses based on acrosome reaction dose response studies described above) or with un-induced cell lysate (negative control) for 20 min at 38° C. Replicate ejaculates were analyzed from a subset of the 25 bulls so that a total of 65 ejaculates were evaluated. Both dairy and beef breeds were represented in the data set. Semen was diluted in a one-step egg yolk citrate TRIS extender and cooled in a water jacket to 5° C.; the straws were packaged and frozen on racks (60 straws/rack) in a liquid nitrogen tank in static vapor. Semen was packaged at either 10, 20, or 25×10⁶ total sperm per straw. Straws were thawed and sperm were incubated for 3 hours at 38° C. The number of motile sperm and the number of sperm that had lost the acrosomal membrane was then determined on a Nikon Eclipse 80i microscope equipped with Nomarski Optics.

Gender-sorted sperm from three bulls were supplemented with rTIMP-2 and rFAA (0 or 25 μg/mL each), cryopreserved, thawed and incubated for 3 hours as described above. Motility (%) and intact acrosomes (%) were recorded as described.

8. Fertility Trial

To determine whether addition of rTIMP-2 and rFAA to semen used for artificial insemination improves fertility, split ejaculates were utilized in fertility trials. Fresh ejaculates were divided equally and one-half was fortified with rTIMP-2 +rFAA (25 μg/mL each), and the remainder of the sample was not treated to serve as a negative control.

Semen was cryopreserved in batch at a constant concentration of sperm (20×10⁶ sperm/straw using standard techniques). Quality control standards confirmed that sperm used in the trial demonstrated ≧50% motility post-thaw. Five Holstein bulls served as semen donors. At least 300 inseminations were assigned per treatment per bull at two locations (1200 total inseminations) in order to generate sufficient statistical power to detect treatment effects on fertility. Fertility will be computed based on pregnancy diagnosis by palpation per rectum conducted by the herd veterinarian approximately 45-60 days post-insemination. A statistically significant increase in fertility is expected.

An additional fertility trial will be conducted using the same recombinant material. However, in this second fertility trial, samples to be fortified will comprise gender-sorted sperm instead of neat semen. Following separation of X chromosome and Y chromosome-bearing sperm, recombinant protein will be added to the samples in the format described above and semen will be cryopreserved at various concentrations of sperm per straw.

9. Statistical Analysis

Data analysis was performed using Excel and SAS/STAT software. The difference in the percentage of sperm with intact acrosomal membranes (PIA) or motility for control and recombinant-treated sperm was analyzed using a paired two-sample T-test. Differences among capacitation treatments were analyzed by ANOVA and Fisher's LSD test. Least squares means were computed for all data. The level of significance was set at p<0.05. Categorical fertility data (successful vs. unsuccessful insemination) resulting from the planned fertility trials will be analyzed using CATMOD procedures in SAS to minimize the deleterious effect of unequal number of inseminations across treatment groups. Main effects will include male, treatment, sperm concentration, batch (ejac.), and all interactions.

### BIBLIOGRAPHY

Altschul, S. F., W. Gish, W. Miller, E. W. Myers and D. J. Lipman. Basic local alignment search tool. J. Mol. Biol., 1990; 215:403-410.
Ax, R. L., K. Dickson, R. W. Lenz. Induction of Acrosome Reactions by Chondroitin Sulfates In Vitro Corresponds to Nonreturn Rates of Dairy Bulls. J. Dairy Sci., 1985; 68: 387-390.
Ax, R. L. and R. W. Lenz. Glycosaminoglycans as Probes to Monitor Differences in Fertility of Bulls. J. Dairy Sci., 1987; 70:1477-1486.
Baumgart, E., S. V. Lenk, S. A. Loening and K. Jung. Tissue inhibitor of metalloproteinases 1 and 2 in human seminal plasma and their association with spermatozoa. Int. J. Androl., 2002; 25(6):369-371.
Bellin, M. E., H. E. Hawkins and R. L. Ax. Fertility of range beef bulls grouped according to presence or absence of heparin-binding proteins in sperm membranes and seminal fluid. J. Anim. Sci., 1994; 72:2441-2448.
Bellin, M. E., H. E. Hawkins, J. N. Oyarzo, R. J. Vanderboom and R. L. Ax. Monoclonal antibody detection of heparin-binding proteins on sperm corresponds to increased fertility of bulls. J. Anim. Sci., 1996; 74:173-182.
Bellin, M. E., J. N. Oyarzo, H. E. Hawkins, H. M. Zhang, R. G. Smith, D. W. Forrest, L. R. Sprott and R. L. Ax. Fertility associated antigen on bull sperm indicates fertility potential. J. Anim. Sci., 1998; 76:2032-2039.
Bendtsen, J. D., H. Nielsen, G. von Heijne and S. Brunak. Improved prediction of signal peptides: SignalP3.0. J. Mol. Biol., 2004; 340:783-795.
Blom, N., S. Gammeltoft and S. Brunak. Sequence- and structure-based prediction of eukaryotic protein phosphorylation sites. J. Mol. Biol., 1999; 294:1351-1362.
Boone, T. C., M. J. Johnson, Y. A. DeClerck and K. E. Langley. cDNA cloning and expression of a metalloproteinase inhibitor related to tissue inhibitor of metalloproteinases. Proc. Natl. Acad. Sci., 1990; 87:2800-2804.
Brew, K., D. Dinakarpandian and H. Nagase. Tissue inhibitors of metalloproteinases: evolution, structure and function. Biochim. Biophys. Acta., 2000; 1477:267-283.
Buchman-Shaked, O., Z. Kraiem, Y. Gonen and S. Goldman. Presence of matrix metalloproteinases and tissue inhibitor of matrix metalloproteinase in human sperm. J. Androl., 2002; 23(5):702-708.
Calvete, J. J., P. F. Varela, L. Sanz, A. Romero, K. Mann and E. Topfer-Petersen. A procedure for the large scale isolation of major bovine seminal plasma proteins. Protein Expr. Purif, 1996; 8:48-56.
Dawson, G. R., M. E. Bellin, J. N. Oyarzo, H. E. Hawkins, M. J. Arns and R. L. Ax. Presence of TIMP-2 on sperm corresponds to fertility of range beef bulls. 27th Am. Soc. Androl. Mtng., 2002; Seattle, Wash. (Abstr. 121).
DeClerck, Y. A., T. D. Yean, B. J. Ratzkin, H. S. Lu and K. E. Langley. Purification and characterization of two related but distinct metalloproteinase inhibitors secreted by bovine aortic endothelial cells. J. Biol. Chem., 1989; 264:17445-17453.
Hulboy, D. L., L. A. Rudolph and L. M. Matrisian. Matrix metalloproteinases as mediators of reproductive function. Mol. Human Reprod., 1997; 3(1):27-45.
Kishi, K., T. Yasuda, S. Awazu and K. Mizuta. Genetic polymorphism of human urine deoxyribonuclease I. Hum. Genet., 1989; 81:295-297.
Lenz, R. W., J. L. Martin, M. E. Bellin and R. L. Ax. Predicting Fertility of Dairy Bulls by Inducing Acrosome Reactions in Sperm with Chondroitin Sulfate. J. Dairy Sci., 1988; 71:1073-1077.
McCauley, T. C., H. M. Zhang, M. E. Bellin and R. L. Ax. Purification and characterization of Fertility-Associated Antigen (FAA) in bovine seminal fluid. Mol. Reprod. Dev., 1999; 54:145-153.
McCauley, T. C., H. M. Zhang, M. E. Bellin, and R. L. Ax. Identification of a heparin-binding protein in bovine seminal fluid as tissue inhibitor of metalloproteinases-2. Mol. Reprod. Dev., 2001; 58:336-341.
McCauley, T. C., G. R. Dawson, J. N. Oyarzo, J. McVicker, S. H. F. Marks and R. L. Ax. Developing and validating a lateral-flow cassette for fertility diagnostics in bulls. In Vitro Diagnostic Technology, 2004; 10:35-40.
Metayer, S., F. Dacheux, J. L. Dacheux and J. L. Gatti. Comparison, characterization, and identification of proteases and protease inhibitors in epididymal fluids of domestic mammals. Matrix metalloproteinases are major fluid gelatinases. Biol. Reprod., 2002; 66(5): 1219-1229.
Nagase, H. and J. F. Woessner, Jr. Matrix metalloproteinases. J. Biol. Chem., 1999; 274:21491-21494.
Parrish, J. J., J. L. Susko-Parrish, M. A. Winer and N. L. First. Capacitation of bovine sperm by heparin. Biol. Reprod., 1988; 38:1171-1180.
Rodriguez, A. M., D. Rodin, H. Nomura, C. C. Morton, S. Weremowicz and M. C. Schneider. Identification, localization, and expression of two novel human genes similar to deoxyribonuclease I. Genomics, 1997; 42:507-513.
SAS User's Guide: Statistics, Version 8.0 Edition. 1999. SAS Inst., Inc., Cary, N.C.
Shimokawa, K, M. Katayama, Y. Matsuda, H. Takahashi, I. Hara and H. Sato. Complexes of gelatinases and tissue inhibitor of metalloproteinases in human seminal plasma. J. Androl., 2003; 24(1):73-77.
Siu, M. K. and C. Y. Cheng. Interactions of proteases, protease inhibitors, and the betal integrin/laminin gamma3 protein complex in the regulation of ectoplasmic specialization dynamics in the rat testis. Biol. Reprod., 2004; 70(4):945-964.
Sprott, L. R., M. D. Harris, D. W. Forrest, J. Young, H. M. Zhang, J. N. Oyarzo, M. E. Bellin and R. L. Ax. Artificial insemination outcomes in beef females using bovine sperm with a detectable fertility-associated antigen. J. Anim. Sci., 2000; 78:795-798.
Sprott, L. R., D. W. Forrest, J. Gallino, A. Novasod, G. Dawson, T. C. McCauley, J. McVicker and R. L. Ax. Fertility-associated antigen in peripubertal beef bulls—A case study. Prof. Anim. Sci., 2006; submitted.
Wilkins, M. R., E. Gasteiger, A. Bairoch, J.-C. Sanchez, K. L. Williams, R. D. Appel, and D. F. Hochstrasser. Protein Identification and Analysis Tools in the ExPASy Server In: 2-D Proteome Analysis Protocols (1998). Editor A. J. Link. Humana Press, New Jersey.

1. A composition of matter for increasing motility or percentage of intact acrosomes (PIA) in sperm, the composition comprising, in combination, an amount of FAA and an amount of TIMP-2, wherein the amounts are effective to increase the motility, the PIA, or the motility and PIA of sperm contacted with the composition.

2. The composition of claim 1, further comprising, in combination, a semen storage media, and wherein the FAA and the TIMP-2 are disposed in the semen storage medium.

3. The composition of claim 2, wherein the semen storage medium comprises Tyrode's albumin-lactate-pyruvate medium (TALP).

4. The composition of claim 2, wherein the amount of FAA in the semen storage medium ranges from about 5 μg/mL to about 200 μg/mL, and the amount of TIMP-2 in the semen storage medium ranges from about 5 μg/mL to about 200 μg/mL.

5. The composition of claim 2, wherein the amount of FAA in the semen storage medium ranges from about 5 μg/mL to about 100 μg/mL, and the amount of TIMP-2 in the semen storage medium ranges from about 5 μg/mL to about 100 μg/mL.

6. The composition of claim 2, wherein the amount of FAA in the semen storage medium ranges from about 10 μg/mL to about 50 μg/mL, and the amount of TIMP-2 in the semen storage medium ranges from about 10 μg/mL to about 50 μg/mL.

7. The composition of claim 2, wherein the amount of FAA in the semen storage is about 25 μg/mL, and the amount of TIMP-2 in the semen storage medium is about 25 μg/mL.

8. The composition of claim 1, wherein the FAA and the TIMP-2 are recombinant proteins.

9. The composition of claim 1, wherein the composition is lyophilized.

10. A method to improve the functionality of sperm, the method comprising
(a) contacting sperm with a composition of matter comprising, in combination, an exogenous amount of FAA and an exogenous amount of TIMP-2, wherein the amounts are effective to increase the motility, the PIA, or the motility and PIA of sperm contacted with the composition.

11. The method of claim 10, wherein in step (a) the composition of matter further comprises a semen storage medium, and wherein the FAA and the TIMP-2 are disposed in the semen storage medium.

12. The method of claim 11, wherein the semen storage medium comprises Tyrode's albumin-lactate-pyruvate medium (TALP).

13. The method of claim 10, wherein in step (a) the sperm is contacted with a composition of matter that yields a concentration of FAA in contact with the sperm of from about 5 μg/mL to about 200 μg/mL, and a concentration of TIMP-2 in contact with the sperm from about 5 μg/mL to about 200 μg/mL.

14. The method of claim 10, wherein in step (a) the sperm is contacted with a composition of matter that yields a concentration of FAA in contact with the sperm of from about 5 μg/mL to about 100 μg/mL, and a concentration of TIMP-2 in contact with the sperm from about 5 μg/mL to about 100 μg/mL.

15. The method of claim 10, wherein in step (a) the sperm is contacted with a composition of matter that yields a concentration of FAA in contact with the sperm of from about 10 μg/mL to about 50 μg/mL, and a concentration of TIMP-2 in contact with the sperm from about 10 μg/mL to about 50 μg/mL.

16. The method of claim 10, wherein in step (a) the sperm is contacted with a composition of matter that yields a concentration of FAA in contact with the sperm of about 25 μg/mL, and a concentration of TIMP-2 in contact with the sperm of about 25 μg/mL.

17. The method of claim 10, wherein the FAA and the TIMP-2 are recombinant proteins.

18. The method of claim 10, wherein step (a) comprises contacting gender-sorted sperm with the composition of matter.

19. The method of claim 10, wherein step (a) comprises contacting non-gender-sorted sperm with a composition of matter.

20. The method of claim 10, further comprising, after step (a):
(b) freezing or cryopreserving the sperm in the presence of the composition of matter.

21. A kit for increasing motility or percentage of intact acrosomes (PIA) in sperm, the kit comprising, in combination:
a composition of matter disposed in a suitable container, the composition comprising an amount of FAA and an amount of TIMP-2, wherein the composition is disposed in a suitable container, and wherein the amounts are effective, in combination, to increase the motility, the PIA, or the motility and the PIA of sperm contacted with the composition; and
instructions for use of the kit.

22. The kit of claim 21, further comprising, in combination, a semen storage media, and wherein the FAA and the TIMP-2 are disposed in the semen storage medium.

23. The kit of claim 22, wherein the semen storage medium comprises Tyrode's albumin-lactate-pyruvate medium (TALP).

24. The kit of claim 22, wherein the amount of FAA in the semen storage medium ranges from about 5 μg/mL to about 200 μg/mL, and the amount of TIMP-2 in the semen storage medium ranges from about 5 μg/mL to about 200 μg/mL.

25. The kit of claim 22, wherein the amount of FAA in the semen storage medium ranges from about 5 μg/mL to about 100 μg/mL, and the amount of TIMP-2 in the semen storage medium ranges from about 5 μg/mL to about 100 μg/mL.

26. The kit of claim 22, wherein the amount of FAA in the semen storage medium ranges from about 10 μg/mL to about 50 μg/mL, and the amount of TIMP-2 in the semen storage medium ranges from about 10 μg/mL to about 50 μg/mL.

27. The kit of claim 22, wherein the amount of FAA in the semen storage is about 25 μg/mL, and the amount of TIMP-2 in the semen storage medium is about 25 μg/mL.

28. The kit of claim 21, wherein the FAA and the TIMP-2 are recombinant proteins.
